(19) United States
(12) Patent Application Publication
(10) Pub. No.: US 2013/0197823 A1
(43) Pub. Date: Aug. 1, 2013

(54) METHOD OF AGGREGATING DATA COLLECTED BY NON-DESTRUCTIVE ULTRASONIC ANALYSIS OF CRIMP QUALITY

(71) Applicant: Keith Williams, West Lafayette, IN (US)

(72) Inventor: Keith Williams, West Lafayette, IN (US)

(21) Appl. No.: 13/753,895

(22) Filed: Jan. 30, 2013

Related U.S. Application Data
(60) Provisional application No. 61/592,642, filed on Jan. 31, 2012.

(51) Int. Cl. G01N 29/44

(52) U.S. Cl. CPC G01N 29/44
USPC 702/39

(57) ABSTRACT

An ultrasonic pulse is transmitted through a crimping tool that compresses a ferule circumscribing a braided multiple strand wire, thereby forming a crimp therebetween. A first received pulse is received from the first transmitted pulse after passage through the crimp. Data is collected from a first transmit window divided into a series of user-defined time periods that include the first transmitted pulse, a delay period following the first transmitted pulse, the first received pulse, and a lag period that extends from the end of the first received pulse to a second transmitted pulse that initiates a second transmit window. The lag period includes a second received pulse generated by delayed signals received from the first transmitted pulse and dead periods that occur before and after the second received pulse, the dead periods substantially lacking signal information from the first transmitted pulse.

### FIELD OF THE INVENTION

This invention relates to nondestructive evaluation of the quality of a crimped connector, and more particularly to evaluation that occurs simultaneously or contemporaneously during formation of the crimped connector.

### BACKGROUND

Electrically conductive stranded wires are frequently terminated with a crimped connection as an alternative to electrical connectors made using soldering, welding, conductive adhesives, and various types of solderless techniques such as insulation displacement, compression, wire clamping and interference fit connections. Crimp connectors are often preferred because they are reliable and inexpensive, easily replaced if damaged, and can provide uniform and reproducible electrical and mechanical characteristics. However, damage to the electrically conductive wires can occur in the immediate vicinity of a crimped connection. This can cause a failure mode that significantly shortens the service life of a crimp connection leading to a failure of a system or vehicle employing the connection. Consequently, it is desirable to reliably and inexpensively evaluate the integrity of a crimped connector.

It is conceivable that an electrical resistance test through a crimped connector may be used to validate or evaluate the connection. However, such testing is not normally done in a production environment due to the high cost and impracticality of such testing, and the inability to accurately predict failures due to certain latent damages such as small nicks or indentations that could be difficult or nearly impossible to detect by resistance testing, but which can create mechanical weaknesses that can propagate and eventually lead to failure.

Another commonly employed technique for determining whether damage has occurred during fabrication of a crimped connector is visual inspection. Unfortunately, visual inspection is not easily employed for small wire diameters or when the crimp connection is not easily accessible, such as when the crimp connector is under a ferrule apron or at a junction between a wire and its insulation.

U.S. Pat. No. 7,181,942 discloses a device and method for evaluating connections made between a crimp connector and a wire. This patent describes an ultrasonic device and method for obtaining desirable crimp connections between a crimp connector and the wire, or bundle of wires, by assessing the desirability of connections made in a wire-to-wire connection and in other situations where two materials with good acoustic propagation characteristics are joined together via deformation. In certain embodiments, a crimping tool comprises a compressing means, pulse-generating circuitry, at least one ultrasonic transmitting transducer, at least one ultrasonic receiving transducer, receiving circuitry, and a display. The user may return to a previously crimped connection and assess the desirability of the connection by compressing the device about the connection, sending an acoustic signal through the crimp, and comparing the received signal to a signal obtained from a known desirable connection.

In the installation of a crimped connector, a wire to be terminated is inserted into a ferrule sized for the wire gauge that is involved. A tool designed to compress, indent and permanently deform a cylindrically shaped ferrule wall around the wire to form a secure and electrically reliable connection of low resistance is used. At the microscopic level of this junction, asperities of the ferrule surface contact the surface of the wire strands, while asperities of the wire strands make contact with the ferrule wall. The deformation process keeps a residual stress on the junction to assure that intimate contact between the surfaces is maintained.

In the case of assembly lines where wiring harnesses are manufactured, the equipment is designed for rapid crimp formation. In wiring harness fabrication processes, many connections are made to smaller wire gauges. This requires the use of smaller diameter ferrules which must be fabricated with tighter tolerances. The jaws used in the crimped tools are also smaller and are held to tighter tolerances. Therefore, crimping apparatus wear is more problematic and can more quickly and easily lead to degradation in crimp quality. Unfortunately, simple conductivity testing is not a reliable indicator of such degradation and such wear results in a crimp having a greater probability of premature malfunction.

The crimping process may be monitored by passing an ultrasonic signal at right angles to the ferrule-wire axis of a hand-held crimp tool as the crimp is formed. The quality of the crimp is evaluated based on transformations in an ultrasonic pulse that is transmitted through the crimp. Factors that affect the ultrasonic pulse transmission are conformability of the ferrule to the tool dies and to the wires, wire ductility, the wire surface area in contact with the ferrule wall, and the residual stress in the ferrule wall that supports a stable crimp geometry. These factors determine a stable areal contact density of asperities between the surfaces. A measurement is taken at the time of maximum compression. This measurement provides information about crimp quality. However, this process ignores other information that may help identify the congruence of parameters that assure a quality crimp with a predictable service life. In addition, this known technology for evaluating crimp quality does not take into consideration any rate dependant mechanisms or position information that can affect the crimp-forming process for systems that operate at high speed or which involved complex geometry.

### BRIEF DESCRIPTION OF THE DRAWINGS

FIG. 1 is a perspective view of primary elements (jaw and anvil) of a typical crimp tool that may be used and/or modified for use in the practice of this invention.

FIG. 2 is an elevational front view of the crimp tool shown in FIG. 1 and showing possible locations of ultrasonic transducer.

FIG. 3 is an enlarged view of the crimp zone formed between the anvil and the jaw.

FIG. 4 is a front elevational view of an embodiment showing an alternate transducer mounting by using an opening in the jaw specifically provided for that purpose.

FIG. 5 is a schematic representation of a system or apparatus for nondestructive evaluation of the quality of a crimped wire connector during installation thereof

FIGS. 6a, 6b and 6c illustrate changes in the position of the jaw relative to the anvil, and changes in the shape of the ferrule and braided wire at sequential times during closure of the tool and crimping of the ferrule against the wire.

FIG. 7 illustrates the characteristic shape of a plot of the amplitude of the ultrasonic wave measured at the receiving transducer as a function of time during the crimping process.

FIG. 8 is an example comparing the amplitude envelope of the ultrasonic response during the crimping process for a seven strand wire having a good crimp, with a seven strand wire having two missing (e.g., broken) strands.

FIG. 9 is a plot of the amplitudes taken by Hilbert Transforms of the ultrasonic transmission responses shown in FIG. 7.

FIG. 10 illustrates that the slope between initial contact and onset of maximum pressure (plastic deformation) differs substantially for the good crimp as compared with the crimp missing two strands.

FIG. 11 illustrates that the slope between initial contact and onset of maximum pressure (plastic deformation) continually decreases with an increasing number of missing strands.

FIG. 12 is an illustration of one transmit pulse, transit time, first received signal, subsequent ringing and reflected signals dampening out over time.

FIG. 13 is an illustration of four transmit pulses and corresponding transit time, first received signal, subsequent ringing and reflected signals dampening.

FIG. 14 is an illustration of approximately 140,000 aggregated first received pulse data subset windows.

FIG. 15 is an illustration of partially analyzed aggregated data subsets from the data subset illustrated in FIG. 14.

FIG. 16 is an illustration of a data envelope to be analyzed.

FIG. 17 is a block diagram of a computer system.

### DETAILED DESCRIPTION

In accordance with certain embodiments of this invention, tool position and ultrasonic transmission across the crimp are used for nondestructive evaluation of crimp quality and for predicting useful service life.

With certain embodiments of the invention, an apparatus is provided for responding to and using rapid crimp formation in automated systems of the type frequently used to increase productivity on assembly line applications for wiring harnesses.

An approach used in certain embodiments of the invention involves establishing a relationship between the ultrasonic transmission through a wire-ferrule interconnection region and the jaw-anvil closure.

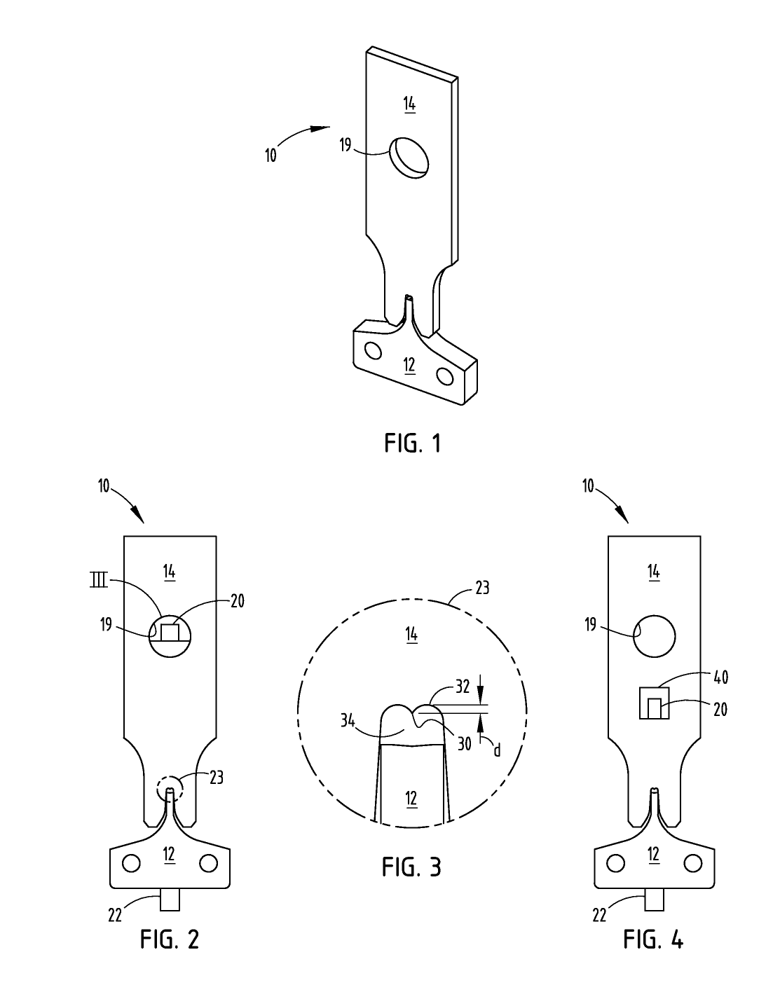

Shown in FIG. 1 is an example of a crimp tool suitable for use with the invention. Crimp tool 10 includes an anvil 12 and a jaw 14 that are movable with respect to one another and which are compressed together to crimp a ferrule against a multiple strand wire in order to establish a crimped electrical connector. Anvil 12 and jaw 14 are typically fabricated from high-strength materials such as steel alloys.

A crimp tool having a transmitting ultrasonic transducer 20 is mounted on jaw 14, and a receiving ultrasonic transducer 22 is mounted on anvil 12. Although in the illustrated embodiment, the transmitter is on the jaw and the receiver is on the anvil, it should be appreciated that suitable alternative embodiments of the invention may employ a transmitting ultrasonic transducer mounted on the anvil and a receiving ultrasonic transducer mounted on the jaw.

As shown in FIG. 2, it is desirable that the transducers 20 and 22 are positioned on the jaw and anvil such that an ultrasonic wave is propagated from the transmitting transducer through the meshing region 23 where a ferrule is crimped onto a wire before being received at receiving transducer 22. It is desirable that the transducers 20 and 22, and the meshing region where crimping occurs are axially aligned transverse to a length direction of the wire.

FIG. 3 shows an enlarged sectional view of the meshing region 23 where crimping of the ferrule against a wire occurs. While not critical, the distance d (the vertical displacement between nib 30 of jaw 14 and the apex 32 of crimp region 34) may be about 0.18 mm.

In FIG. 4, an alternative embodiment includes an opening 40 separate from anchor opening 19 for transducer 20.

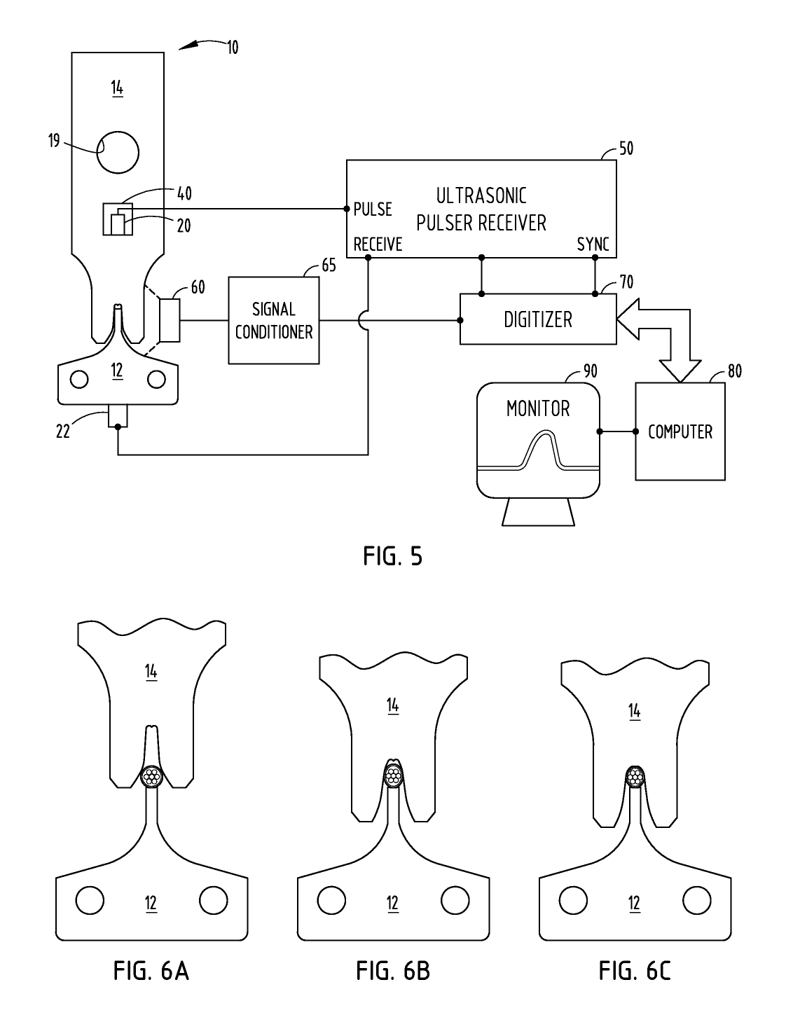

FIG. 5 schematically illustrates a system or apparatus for nondestructive evaluation of the quality of a crimped wire connector in accordance with certain embodiments of the invention. The system includes an ultrasonic pulser-receiver 50 for providing an electrical signal to transmitting ultrasonic transducer 20 that is converted into an ultrasonic wave, and for receiving an electrical signal from receiving transducer 22 indicative of a received waveform from receiving transducer 22. A position sensor 60 detects the position of jaw 14 relative to anvil 12 and transmits an electrical signal via a signal conditioner 65 to a digitizer 70 that also receives signals from ultrasonic pulser-receiver 50. Positional and ultrasonic wave characteristic data can be measured, digitized and transmitted to a computer 80 during the crimping operation. This digitized information can be analyzed by a computer employing algorithms for comparing the measured information with similar information obtained previously for wire connectors having a known quality characteristic (e.g., characteristic of crimp quality, expected useful life, etc.).

FIGS. 6a, 6b and 6c show the sequence of compression stages from the beginning to the end of the compression cycle.

As the ultrasonic waves are traversing the crimp tool and the jaw-anvil separation is decreasing, both ultrasonic data and positional data are detected and recorded. The sequence for measurement is as follows: (1) a synchronizing pulse begins the process by causing the jaw opening to be measured and by causing the ultrasonic pulser-receiver 50 to send a pulse to the ultrasonic transmitter 20, and starting the timing measurement for the digitizer (triggers the digitizer). The time (x-axis), the received waveform (from transducer 22 (y-axis)) are plotted on the monitor. A record of time, received waveform and jaw opening is made. This sequence is repeated every pulse cycle. A window may be set to record the first received waveform at the receiving transducer for every pulse cycle. The ultrasonic data and jaw position data can be recorded at a set rate (e.g., one pulse every two milliseconds). Typically, the transit time for the first received ultrasonic waveform is on the order of ten microseconds. Therefore the transit time is less than than 1/100 of the pulse cycle time. Consequently, first-received waveforms are plotted sequentially. Throughout the operation, the voltage pulses applied to the transmitting transducer remains uniform (i.e., each pulse applied to the transmit transducer is identical in shape and height).

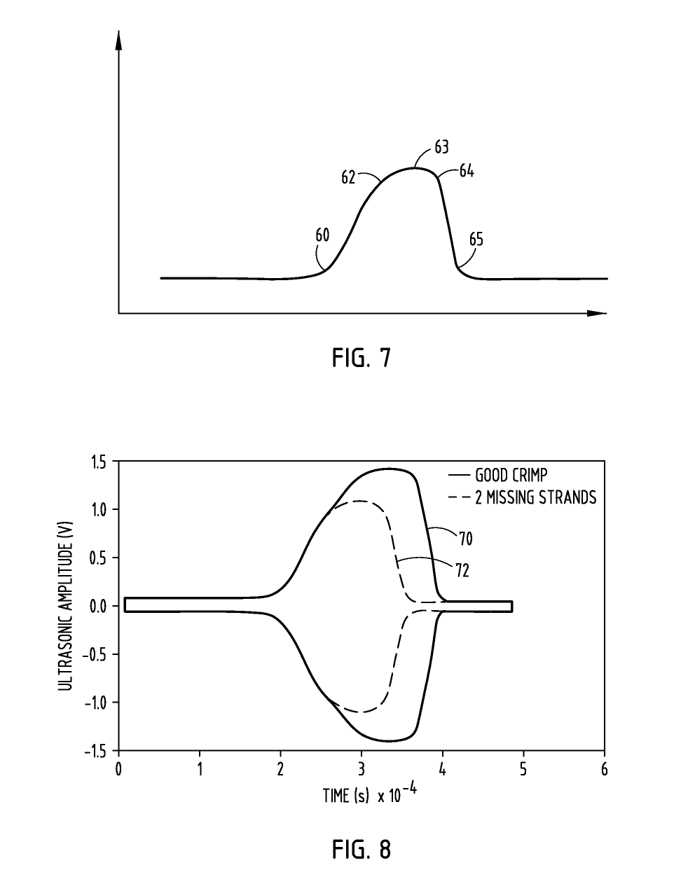

FIG. 7 shows a schematic diagram of a plot of ultrasonic wave amplitude versus time that is characteristic of the crimping process. During the crimping process, the amplitude of the ultrasonic wave propagated through the ferrule-wire from the jaw to the anvil slowly begins to increase at a point of initial contact 60. As the compression cycle progresses, a point at 62 is reached at which the onset of maximum pressure occurs. Maximum ultrasonic transmission (amplitude) reaches a maximum at point 63. At point 64, maximum pressure is released, and separation between the jaw and the crimped connection occurs at point 65.

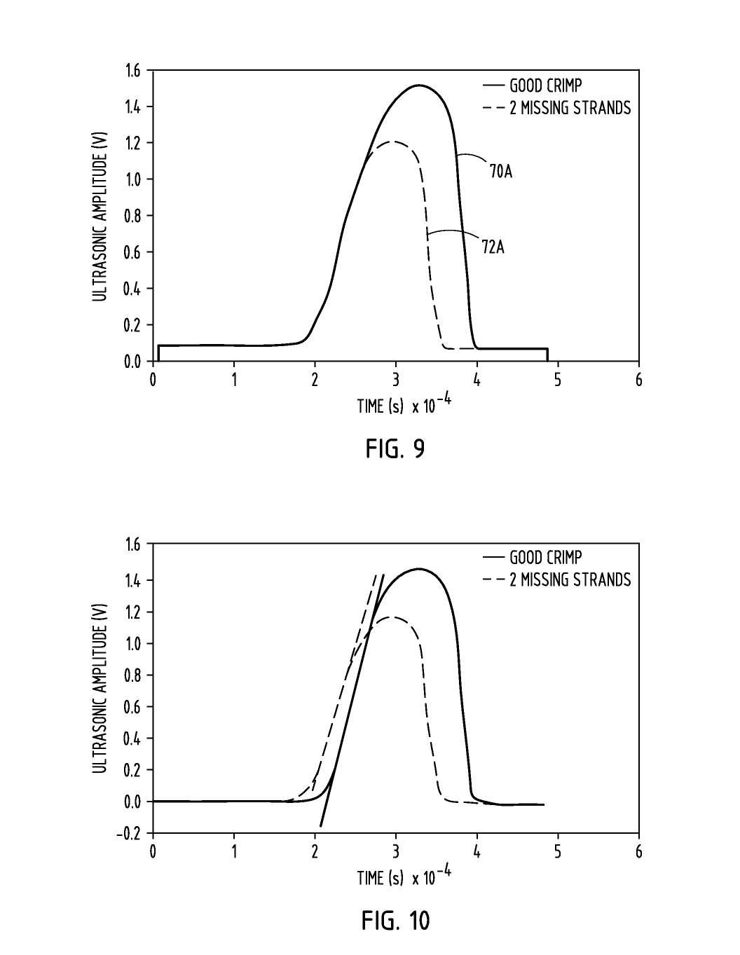

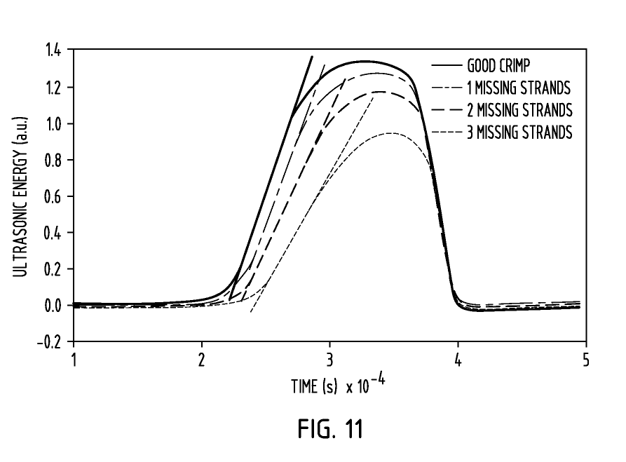

FIG. 8 shows a schematic diagram of a plot of ultrasonic received signals versus time for two crimped connections employing the same wire gauge and using the same tools and ferrule, with curve 70 being for a good crimp, and curve 72 being for a crimp having two missing strands out of seven total strands. It is useful to represent this data in a Hilbert Transformation as shown in FIG. 9. Curve 70A represents the Hilbert Transform of curve 70 shown in FIG. 8 and curve 72A represents the Hilbert Transform of curve 72 shown in FIG. 8. The plotted data in FIGS. 8 and 9 show that a good crimp has a quantitatively different slope between the initial contact point and the onset of maximum pressure (plastic deformation) than the slope between initial contact and onset of maximum pressure for a bad crimp (e.g., a crimp having missing strands). Additionally, it can be observed that the maximum ultrasonic transmission amplitude is greater for the good crimp than for the bad crimp. Also, the slope between the maximum pressure release and the separation (elastic spring-back) is a measure of the ability for the crimped wire-ferrule structure to maintain its conformality. This property depends upon the elastic properties of the wall of the ferrule and the wire. If the temper of either the ferrule or the wire is out of specification (as can sometimes occur when proper manufacturing procedures are not followed) then the slope will change.

Determination of numerical values are based on an average cycle with good crimps. The mechanical performance of the machine can be verified by manufacturer's recommended procedures to meet or exceed specifications. The good crimps can be independently verified by destructive test procedures consistent with good practices. Once verified, the mean and standard deviation of the compression and pressure release slopes (volts/second if measured against time, or pulses/millimeters if measured against jaw-anvil separation) for the good crimp is determined and stored. Similarly, the maximum height can also be determined and stored. These values can subsequently be prepared with each crimp formed during the full production cycle. Any crimp falling outside of a predetermined limit (e.g., more than three standard deviations above or below) can be rejected to assure that potential production problems are avoided.

The test interpretations can be based on the development of pathology maps, as demonstrated within the examples (e.g., missing strands). It is expected that the compression slope, the ultrasonic maximum transmission, and the pressure release or elastic spring-back slope can characterize the crimp quality. Other pathologies that can potentially be characterized include machine malfunctions, deviations from nominal design values for dimension or temper for the wire and/or ferrule, the wire thickness, the presence of missing strands, wire contamination with foreign substances, insulation slivers or sections caught inside the crimp zone, etc.

For each pathology listed, a certain pattern among the slopes and the maximum pulse height will develop and hence identify the pathology.

Although the invention is expected to be particularly well suited for high speed automated crimping processes, the technology can be employed with manual (hand) operated crimping tools. The invention can also be employed on battery powered, electric or pneumatically powered hand tools. The mode of power or portability of the tooling is independent of the applicability of the technology. The same technology outlined above can be employed with tools of multiple jaws or anvils. It is not restricted to tooling with one jaw and anvil but can be applied to multi-pin indenter type tools. The technology disclosed herein can be incorporated into the design of new tools or it can be designed to form an add-on attachment that is field-installable.

The maximum electronics and typical ultrasonic specifications for the components are as follows: transducers (typically damped units of diameter ¼ inches to ⅛ inches) 5 MHz to 50 MHz, depending on wire gauge pulser-receiver (analog from 1 MHz to 200 MHz bandwidth, with pulse width, pulse maximum voltage and pulse energy settings appropriate for transducer selection) with pulse rate settings stable to parts in 105 over several months. Digitizer minimum of 8 bits or better at 100 Msample/second digitizing rate or better, input levels to match output from pulser-receiver and input to match output from position sensor and signal conditioner. Position sensor sensitivity to 10 micrometer sensitivity and capacity to span full range of jaw-anvil motion.

The maintenance, reliability and safety factors largely depend upon the manufacturer's product to which the technology of this invention is implemented.

By combining ultrasonic date with positional information (jaw-to-anvil distance) substantially more physical information about crimp quality, including plastic deformation and elastic spring-back can be characterized. The additional information makes it more likely to identify crimps with limited service life due to contamination and improperly tempered ferrules or connectors. The systems of this invention can be self calibrating. However, calibration can drift and should be repeated periodically. The period for recalibration can be determined by experience with the technology. Other than misalignment of transducers or jaw-anvil misalignment, sources of error are primarily improper adjustment or electronic settings, and calibration drift of transducers or circuits. Analysis of the data collected shows good sensitivity to missing strand pathologies. Other pathologies and their signatures can be developed using the apparatus and processes described herein.

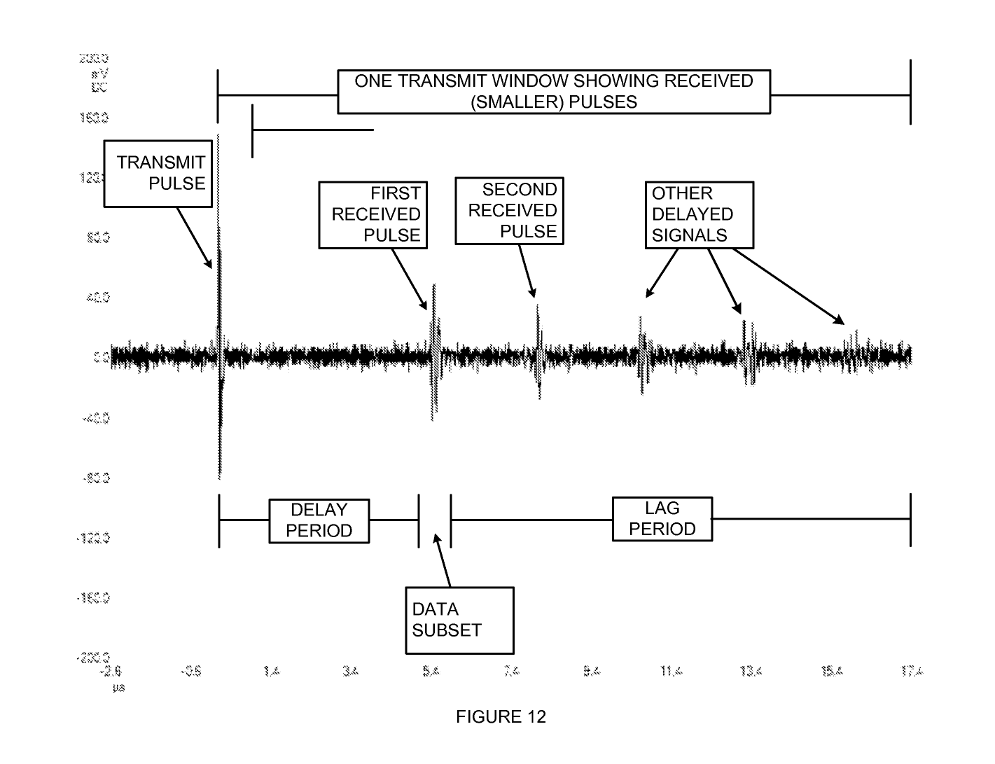

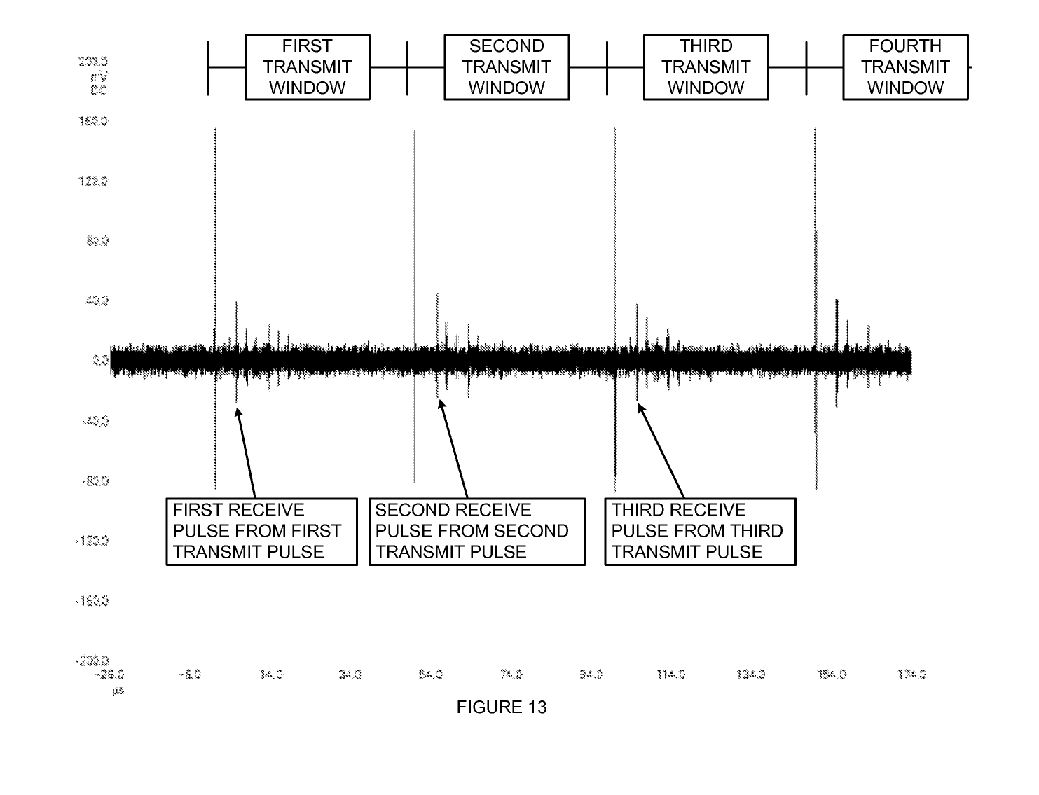

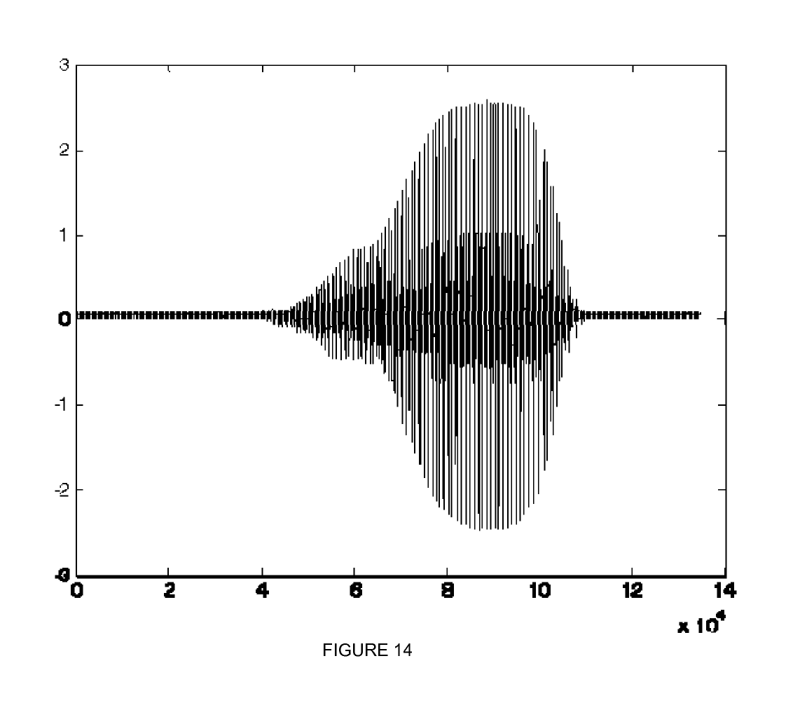

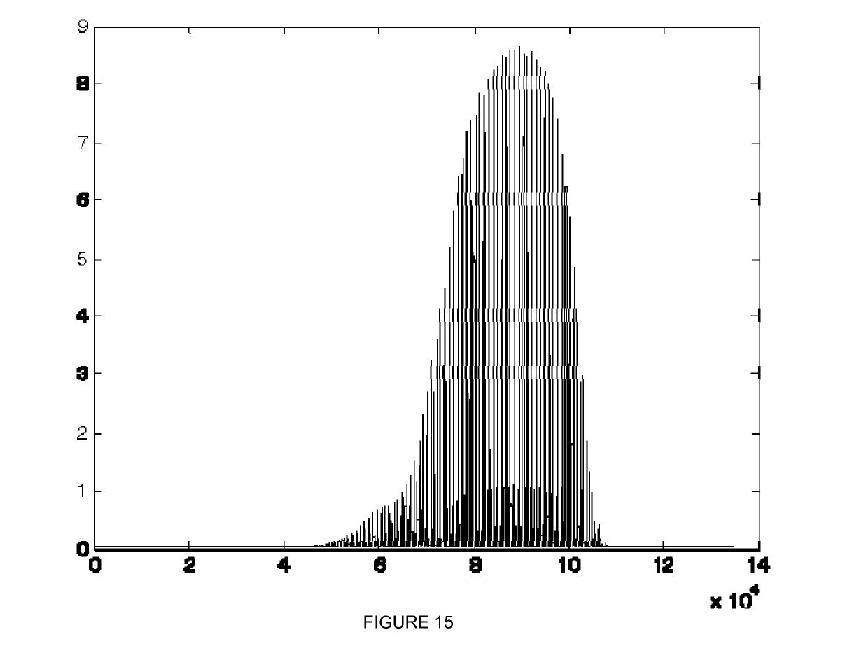

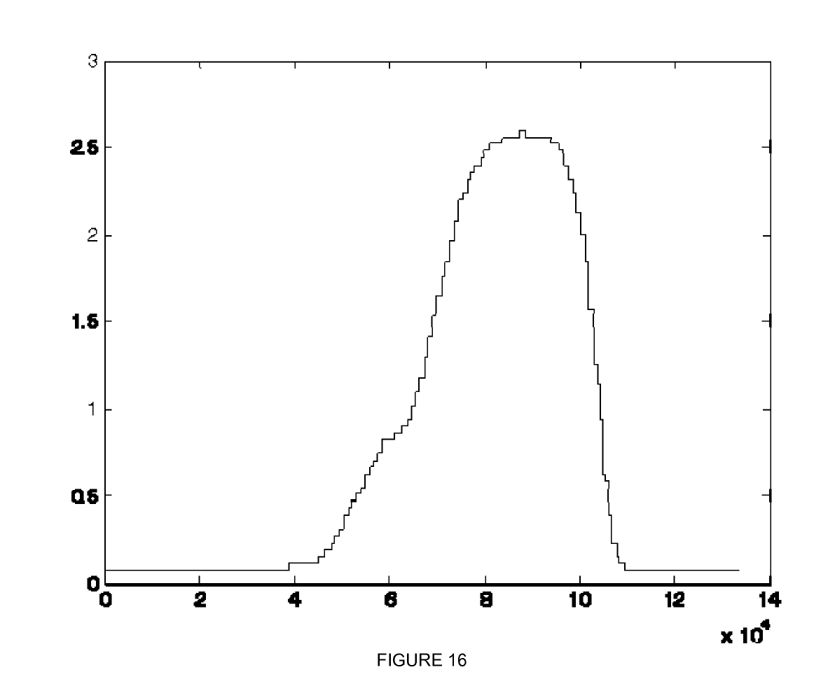

Referring now to FIGS. 12 through 16, ultrasound may be utilized as a measurement of crimp quality. In one form, the technology transmitted an ultrasonic pulse through tooling, through the connector and wire being crimp, through the opposite side tooling, finally being received and then analyzed. In this form, the analysis was based on the repetitive analysis of this short transmitted and then received burst—all in a fairly static mechanical implementation.

In highly dynamic systems, particularly automated crimp systems, a more comprehensive data collection and analysis method may yield more accurate and detailed results by allowing such a system to identify specific failure modes as well as make a crimp quality determination. Of particular difficulty with the original schemes is sorting through the data in real time to make sure that a pulse at exactly the bottom-most travel of the crimp tool is transmitted and then received and ultimately captured for analysis.

In order to address a more comprehensive data collection requirement, a capture of all of the information received by the receiving transducer would need to be logged throughout the cycle. Additionally, this data would have to be sorted and analyzed in real-time to allow for such an instrument to have value within the crimp production industry. Cycle times can run from greater than 1 second to less than 200 mS. Currently the sample rate of the digitizer is 1 sample every nanosecond—faster data rates may ultimately be used. This leads to a huge volume of data over the entire crimp press cycle that must be sorted through and analyzed within a very short period of the press completing its cycle.

In an embodiment, within this stream of data, there are extended periods of time that do not contribute to a final analysis. An embodiment allows for the automatic aggregation of only the time-samples of interest by means of synchronization to the transmit pulse (or burst), a delay to begin capturing data that is some combination of transit time of the pulse through the system plus any additional delay deemed desirable, a capture window, and then an ending time to stop capturing data (this creates a sample window). In an embodiment, these aggregated windows ultimately form the basis for what is analyzed. There may be multiple ‘sample windows’ per each transmit pulse. Upon the collection of all sample windows for the current transmit pulse(s), the system ignores further data until a new synchronization event occurs resetting the acquisition cycle. The new data is then appended to the end of the last dataset or can be stored individually for segmented analysis. In aggregated form, the data can be further aligned by matching zero-crossing points to smooth spectral analysis by removing instantaneous discontinuities within the data.

Upon collection of all of these dataset(s) over the press cycle, the data resembles an envelope that can be analyzed in its entirety, or individual portions of the dataset can be disaggregated for further individual analysis. The data envelope, however, represents a full picture of the crimp as it is being formed allowing for many for defining characteristics of the formed crimp to emerge.

The methods, analysis, systems, devices, equipment, and functions described above may be implemented with or executed by one or more computer systems. The methods described above may also be stored on a computer readable medium.

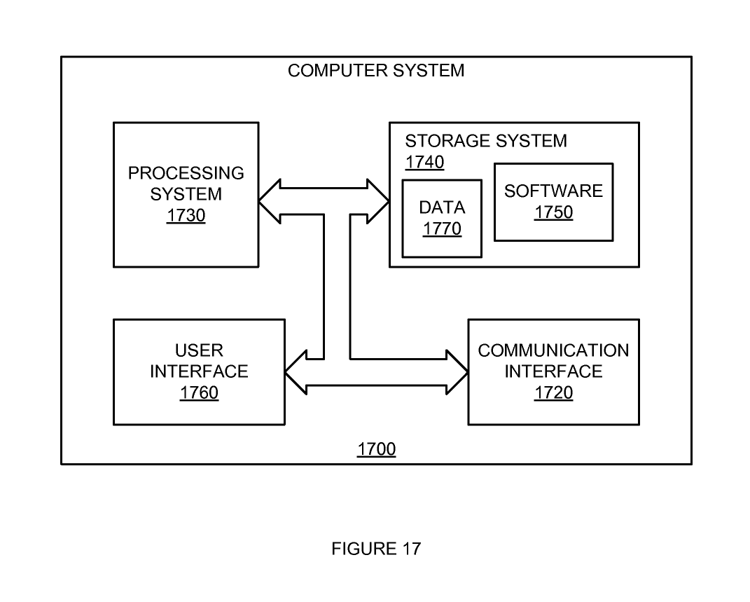

FIG. 17 illustrates a block diagram of a computer system. Computer system 1700 includes communication interface 1720, processing system 1730, storage system 1740, and user interface 1760. Processing system 1730 is operatively coupled to storage system 1740. Storage system 1740 stores software 1750 and data 1770. Processing system 1730 is operatively coupled to communication interface 1720 and user interface 1760. Computer system 1700 may comprise a programmed general-purpose computer. Computer system 1700 may include a microprocessor. Computer system 1700 may comprise programmable or special purpose circuitry. Computer system 1700 may be distributed among multiple devices, processors, storage, and/or interfaces that together comprise elements 1720-1770.

Communication interface 1720 may comprise a network interface, modem, port, bus, link, transceiver, or other communication device. Communication interface 1720 may be distributed among multiple communication devices. Processing system 1730 may comprise a microprocessor, microcontroller, logic circuit, or other processing device. Processing system 1730 may be distributed among multiple processing devices. User interface 1760 may comprise a keyboard, mouse, voice recognition interface, microphone and speakers, graphical display, touch screen, or other type of user interface device. User interface 1760 may be distributed among multiple interface devices. Storage system 1740 may comprise a disk, tape, integrated circuit, RAM, ROM, network storage, server, or other memory function. Storage system 1740 may be a computer readable medium. Storage system 1740 may be distributed among multiple memory devices.

Processing system 1730 retrieves and executes software 1750 from storage system 1740. Processing system 1730 may retrieve and store data 1770. Processing system 1730 may also retrieve and store data via communication interface 1720. Processing system 1730 may create or modify software 1750 or data 1770 to achieve a tangible result. Processing system 1730 may control communication interface 1720 or user interface 1760 to achieve a tangible result. Processing system may retrieve and execute remotely stored software via communication interface 1720.

Software 1750 and remotely stored software may comprise an operating system, utilities, drivers, networking software, and other software typically executed by a computer system. Software 1750 may comprise an application program, applet, firmware, or other form of machine-readable processing instructions typically executed by a computer system. When executed by processing system 1730, software 1750 or remotely stored software may direct computer system 1700 to operate as described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of aggregating data collected by non-destructive ultrasonic analysis of crimp quality, the method comprising the steps of:
exciting a transmitting ultrasonic transducer with a first transmitted pulse comprising at least one pulse, the ultrasound transmitter being operatively connected to a crimping tool having movable segmented machine tooling together receive and compress a ferule circumscribing a braided multiple strand wire, thereby forming a crimp therebetween;
detecting a first received pulse using a receiving ultrasonic transducer operatively connected to the crimping tool, the first received pulse comprising initial signals received from the first transmitted pulse after passage through the crimp;
acquiring data collected from a first transmit window divided into a series of user-defined time periods that include the first transmitted pulse, a delay period following the first transmitted pulse, the first received pulse, and a lag period that extends from the end of the first received pulse to a second transmitted pulse that initiates a second transmit window, the lag period including at least a second received pulse generated by delayed signals received from the first transmitted pulse and a plurality of dead periods that occur before and after the second received pulse, the dead periods substantially lacking signal information from the first transmitted pulse;
selecting and storing a user-defined data subset from the first transmit window, the data subset selected to include at least a substantial portion of the first received pulse;
discarding selected data acquired from the first transmit window, the discarded data including at least a portion of the first delay period and a least a portion of plurality of dead periods within the lag period such that the selected data subset requires substantially less storage space than would the entire data set acquired during the first transmit window;
repeating the above steps to acquire and store selected data collected from a plurality of transmit windows;
aggregating the selected data from the plurality of transmit windows to create an aggregate data set, and,
analyzing the aggregate data set to evaluate attributes of the crimp.

2. The method of claim 1 wherein the selected subset of data from the plurality of transmit windows further comprises at least the second received pulse.

3. The method of claim 1, wherein the aggregate data comprises a plurality of data subsets from the plurality of transmit windows that are appended together and analyzed collectively.

4. The method of claim 1, wherein the aggregate data comprises a plurality of data subsets from the plurality of transmit windows is subsequently disaggregated for individual analysis.

5. The method of claim 1, wherein the discarded portion of the selected data is discarded after being received by the receiving ultrasonic transducer.

6. The method of claim 1, wherein the discarded portion of the selected data is discarded by turning off the receiving ultrasonic transducer during the delay and the dead periods.
